(19) United States
(12) Patent Application Publication
(10) Pub. No.: US 2011/0002019 A1
(43) Pub. Date: Jan. 6, 2011

(54) HOLOGRAPHIC IMAGE DISPLAY SYSTEMS

(75) Inventors: Paul Richard Routley, Cambridge (GB); Alexander David Corbett, Oxford (GB); Adrian James Cable, Harlton (GB); Gareth John McCaughan, Cambridge (GB)

Correspondence Address: KNOBBE MARTENS OLSON & BEAR LLP, 2040 MAIN STREET, FOURTEENTH FLOOR, IRVINE, CA, 92614, US

(73) Assignee: LIGHT BLUE OPTICS LTD, Cambridge (GB)

(21) Appl. No.: 12/831,195

(22) Filed: Jul. 6, 2010

Related U.S. Application Data
(63) Continuation-in-part of application No. PCT/GB2008/051211, filed on Dec. 19, 2008.

(30) Foreign Application Priority Data
Jan. 7, 2008 (GB) 0800167.9

(51) Int. Cl. G03H 1/32; G02B 5/32; G03H 1/08; G02B 27/48

(52) U.S. Cl. 359/9; 359/32; 359/15; 353/38

(57) ABSTRACT

The invention relates to techniques for speckle reduction in holographic optical systems, in particular holographic image display systems. We describe a holographic image display system for displaying an image holographically on a display surface, the system including: a spatial light modulator (SLM) to display a hologram; a light source to illuminate said displayed hologram; projection optics to project light from said illuminated displayed hologram onto said display surface to form a holographically generated two-dimensional image, said projection optics being configured to form, at an intermediate image surface, an intermediate two-dimensional image corresponding to said holographically generated image; a diffuser located at said intermediate image surface; and an actuator mechanically coupled to said diffuser to, in operation, move said diffuser to randomise phases over pixels of said intermediate image to reduce speckle in an image displayed by the system.

### CROSS-REFERENCE TO RELATED APPLICATIONS

This application is a continuation-in-part of International Application No. PCT/GB2008/051211, filed Dec. 19, 2008, designating the United States and published in English on Jul. 16, 2009 as WO 2009/087358 and incorporated in its entirety by reference herein, which claims the benefit of United Kingdom Appl. No. 0800167.9, filed Jan. 7, 2008 and incorporated in its entirety by reference herein.

### BACKGROUND OF THE INVENTION

1. Field of the Invention

This invention relates to techniques for speckle reduction in holographic optical systems, in particular holographic image display systems.

2. Description of the Related Art

Speckle is a problem in holographic image display systems, in particular those which display an image on a two-dimensional (though not necessarily planar) screen. This is because images are generated using coherent light and when this falls on a surface, unevenness at the wavelength scale or greater causes interference in the eye of the observer and hence speckle in the displayed image. Inter-pixel interference also results in an effect which has a visual appearance similar to speckle, although in this case the effect arises independently of the properties of the surface or the observer's eye.

One technique which may be employed to reduce speckle when replaying a holographic image is described in EPO 292 209A. This describes the fabrication of a composite hologram using separate exposures with different speckle fields generated using a diffuser. A technique for speckle reduction in a non-holographic image display system can be found in WO2006/104704. Other similar background prior art can be found in EP1 292 134A, US2006/0012842, WO98/24240, and U.S. Pat. No. 6,747,781. A system using a 1-dimensional spatial light modulator, scanned to generate a 2D image, is described in “Hadamard speckle contrast reduction”, J. I. Trisnadi, Optics Letters 29, 11-13 (2004) and in Trisnadi, Jahja I., “Speckle contrast reduction in laser projection displays” Silicon Light Machines, Sunnyvale, Calif. 94089, as well as U.S. Pat. No. 7,214,946, U.S. Pat. No. 7,046,446 and related patents.

We have previously described techniques for displaying an image holographically (see, for example, WO 2005/059660, WO 2006/134398 and WO 2006/134404, all hereby incorporated by reference in their entirety). These techniques, which display multiple temporal sub-frames for a single image frame, have advantages in reducing inter-pixel interference caused by adjacent pixels having decorrelated phase values, and additional advantages in reducing speckle because temporally sequential sub-frames produce images with substantially independent spatial phase structure, leading to independent speckle patterns which average in the eye of the observer. However further speckle reduction is desirable.

### SUMMARY OF THE INVENTION

According to certain embodiments of the present invention there is therefore provided a holographic image display system for displaying an image holographically on a display surface, the system comprising: a spatial light modulator (SLM) to display a hologram; a light source to illuminate said displayed hologram; projection optics to project light from said illuminated displayed hologram onto said display surface to form a holographically generated two-dimensional image, said projection optics being configured to form, at an intermediate image surface, an intermediate two-dimensional image corresponding to said holographically generated image; a diffuser located at said intermediate image surface; and an actuator mechanically coupled to said diffuser to, in operation, move said diffuser to randomise phases over pixels of said intermediate image to reduce speckle in an image displayed by the system.

Broadly speaking embodiments of the system provide a phase pattern across the intermediate image of the displayed hologram enabling a plurality of different, in embodiments independent, speckle patterns to be generated which, if displayed sufficiently quickly, average within the eye to reduce speckle. The phase pattern may be random or computed/pseudo-random, that is having a random characteristic to function as a light diffuser, but with a controlled, more particularly limited, spatial (angular) intensity distribution for the diffused light.

In embodiments the intermediate image surface comprises a Fourier transform plane of the phase imprint of the SLM. A version of the displayed image is formed at this surface, at a resolution determined (in part) by the number of pixels of the SLM.

In many cases the intermediate image surface comprises a plane but in embodiments it may be a curved surface, depending upon the location of the surface within the projection optics and on whether the display surface is curved. (We have previously described techniques for projecting onto a curved display surface, for example for a head-up display, in our co-pending applications GB0706264.9 and U.S. 60/909,394 hereby incorporated in their entireties by reference herein).

In embodiments the projection optics may comprise demagnification optics such as a beam expander or reverse Keplerian telescope, one or more lenses of which may be encoded in the hologram display on the SLM. In some preferred embodiments the SLM comprises a reflective SLM.

In preferred embodiments the holographic image display system comprises an “OSPR-type” system (described in detail later) in which multiple temporal subframes are displayed for each displayed image (frame). In embodiments of this technique the phases of pixels of successive frames are pseudo-random, albeit that in some preferred implementations noise generated by one subframe is compensated for in one or more subsequent subframes (which technique the inventors term adaptive (AD) OSPR).

Broadly speaking, OSPR reduces speckle noise power at spatial frequencies up to a frequency dependent on the inverse pixel pitch in the intermediate image plane. If a minimum feature size of pixel pitch of the diffuser is no smaller than a pixel pitch of the image in the intermediate image plane then the diffuser has the effect of adding more temporal subframes, since the OSPR procedure effectively randomises the pixel phases of each successive subframe.

In a non-OSPR holographic image display system the effect is somewhat akin to that inherently achieved by OSPR. With OSPR, however, preferably a pixel pitch or feature size of the diffuser is less than that of the intermediate holographically generated image, in which case speckle is reduced at increased spatial frequencies than would otherwise be the case, up to a spatial frequency determined by the inverse of the diffuser pixel pitch or feature size.

Since the intermediate image and diffuser are both two-dimensional preferably the diffuser pixel pitch is less than the intermediate image pixel pitch in each of two corresponding orthogonal directions (x and y directions) in the intermediate image plane. In some preferred implementations the diffuser is moved in two dimensions (x and y directions) to reduce “streaking” in the image.

We have previously described, in PCT/GB2007/050291 (hereby incorporated in its entirety by reference herein) techniques for displaying colour images holographically. Thus in embodiments the light source may provide illumination at more than one wavelength, and may include beam expanding/combining or other optics. In some implementations of a colour display system pixels of different colours (wavelengths) may have substantially the same size in the displayed image plane. In other implementations the pixel sizes are generally proportional to the wavelengths of the incident light. In this latter type of system it is preferable for a pixel of the diffuser to be smaller than a smallest intermediate image pixel size, for example a blue wavelength intermediate image pixel size.

It has been found, in practice, that noise reduction resulting from OSPR-type phase randomisation and speckle reduction from a diffuser with pixels smaller than those of the intermediate image multiply together to give substantially lower perceived speckle and reduce speckle contrast.

The diffuser may comprise ground glass with a feature size less than a pixel pitch of the intermediate image (for example a phase change of at least, say, π/4 over this distance). However, because ground glass is typically rough over a range of length scales if feature sizes at this scale are present then generally there will also be smaller features. These will tend to scatter the light over a wide range of angles, a proportion of the light being scattered beyond an acceptance angle of a final lens of the projection optics, thus resulting in a reduced intensity displayed image. It is therefore useful to employ a specially computed diffuser to match the acceptance angle of a final lens of the projection optics and/or optimise the depth of field of the system. (This is described in more detail later). A pixilated quantised phase diffuser may be employed without significant penalty.

Additionally or alternatively it can be useful to employ a diffuser with a minimum feature size constraint, for example 1/10^{th}, 1/50^{th} or 1/100^{th} of a pixel pitch in the intermediate image plane (this depends on the collection angle of the final lens). To limit the minimum feature size whilst providing diffuser features less than an intermediate image pixel pitch a pixellated quantised phase diffuser may be employed. This may be a binary phase diffuser with phases of, for example, 0 and π, or more than two phase levels may be employed. In embodiments the pixels of the diffuser may have a pixel pitch of less than 5 μm, 4 μm, 3 μm, 2 μm or 1 μm. A pixel of the diffuser may have one of a plurality of quantised phase levels. Thus, in embodiments, the diffuser comprises a pixellated array with one of two phases for each pixel chosen with a 50% probability. The phase pattern may be random or computed/pseudo-random, that is having a random characteristic to function as a light diffuser, but with a controlled, more particularly limited, spatial (angular) intensity distribution for the diffused light.

The actuator may comprise a motor but in preferred embodiments a piezoelectric actuator is employed. Preferably the stroke of the actuator is sufficient for at least 2, 5 or 10 different phase patterns (diffuser pixels) to be imposed on an intermediate image pixel. Thus, depending upon pixel sizes, in some preferred embodiments the piezoelectric actuator has a stroke of at least 5 μm, more preferably at least 10 μm. For the different speckle patterns caused by the different imposed phase patterns to integrate within the human eye the different phase patterns should be imposed sufficiently quickly for the speckle patterns to average within an observer's eye, for example in less than 1/30^{th}, preferably less than 1/60^{th} of a second. A routine experiment can be employed to trade off stroke length and speed of movement and the actuator may be operated either on-resonance or off-resonance (also taking into account the desirability of low audio noise from the actuator). For example the actuator may operate at a frequency of between 10 Hz and 10 KHz.

As previously mentioned, the above described techniques are particularly advantageous in a holographic image display system which generates a plurality of temporal holographic subframes for display in rapid succession on the SLM such that corresponding temporal subframe images on the display surface average in an observer's eye to give the impression of the displayed image. This technique can reduce speckle in the projected image up to a spatial frequency dependent on the (inverse) intermediate image pixel pitch in the Fourier transform plane of the SLM, and, in cases where the diffuser pixel pitch is less than this, speckle at increased spatial frequencies can be reduced. Where the diffuser pixel pitch is not less than that of the intermediate, holographically-generated image, effectively the “OSPR-effect” is enhanced.

Thus, in a related aspect certain embodiments of the invention provide a method of reducing speckle in a holographic image display system for holographically displaying an image comprising a plurality of pixels on a display surface, the system comprising: a spatial light modulator (SLM) to display a hologram; a light source to illuminate said displayed hologram; projection optics to project light from said illuminated displayed hologram onto said display surface to form a holographically generated two-dimensional image, said projection optics being configured to form, at an intermediate image surface, an intermediate two-dimensional image corresponding to said holographically generated image; and a diffuser located at said intermediate image surface, the system being configured to generate a plurality of temporal holographic subframes for display in rapid succession on said SLM such that corresponding temporal subframe images on said display surface average in an observer's eye to give the impression of said displayed image; the method comprising moving said diffuser to provide within the area of each said pixel a plurality of different phases sufficiently quickly for a resulting changing speckle pattern to be integrated in the eye of a human observer to reduce a perceived level of speckle.

Preferably the diffuser has pixels of a pitch less than that of an intermediate, holographically-generated image in the system such that speckle is reduced at a spatial frequency higher than a maximum spatial frequency of the displayed image. Preferably the diffuser is moved by more than 2, 5 or 10 diffuser pixels within at least the time duration of an image frame, optionally within the duration of one or more temporal subframes.

In some preferred embodiments of the method the diffuser has a pseudo-random computed pattern which is computed to provide a predetermined intensity distribution for light diffused by the diffuser. In embodiments the diffuser may be computed as a phase hologram; in some preferred embodiments it has a pattern of pixels of quantised phase which have values which are computed to achieve a pattern, more particularly angular intensity distribution of light diffused by the diffuser. In some embodiments this pattern is computed such that the diffuser defracts or diffuses light into a disc, preferably this disc at least substantially filling a clear aperture of an imaging device (lens or mirror) imaging the diffuser. In embodiments the diffuser pattern, more particularly the disc, is computed so that the diffused light substantially matches an acceptance angle of an imaging device imaging the intermediate imaging surface of the projection optics. Additionally or alternatively the (pseudo-random) computed pattern on the diffuser may be calculated to optimise a depth of field of the system, more particularly to maximise speckle reduction for a determined depth of field of the holographic image display system (for example, a design depth of field or a measured depth of field). In this latter case the pattern on the diffuser may be configured to defract light into a disc, the disc having light intensity which falls off with radius from the centre according to a power law, more particularly dependent on the square of the radius, in embodiments (1−r²). In some preferred embodiments a disc of the diffused light at least substantially fills a clear aperture of the imaging device, typically the output optics, and may “over fill” the input aperture of the output optics.

Although the above described techniques are particularly advantageous with systems configured to generate a displayed image holographically they may also be employed with image projection systems which employ coherent light, or at least partially coherent light, to illuminate a transmissive or reflective SLM (for example, a digital light processor, DLP) displaying an image for projection on to a display surface rather than displaying a hologram.

Thus certain embodiments of the invention also provide an image display system to project an image onto a display surface using at least partially coherent light, the system comprising: a spatial light modulator (SLM) to display a two-dimensional image; an at least partially coherent light source to illuminate said displayed image on said SLM; projection optics to project light from said illuminated display image onto said display surface to form a two-dimensional image, said projection optics being configured to form an intermediate two-dimensional image corresponding to said displayed image; a pixellated, quantised phase diffuser located at a position of said intermediate two-dimensional image; and a piezoelectric actuator mechanically coupled to said diffuser to, in operation, move said diffuser to change a speckle pattern of said projected two-dimensional image, whereby, in operation, said changing speckle pattern of said projected two-dimensional image resulting from movement of said diffuser averages in a human observer's eye to reduce a perceived level of speckle.

In some preferred embodiments the preferred diffuser has a pixel pitch less than the intermediate image pixel pitch. In embodiments the diffuser has a pixel pitch of less than 5 μm, 4 μm, 3 μm, 2 μm or 1 μm. Preferably, the actuator (preferably a piezoelectric actuator) is configured to move the diffuser in two dimensions.

### BRIEF DESCRIPTION OF THE DRAWINGS

These and other aspects of the invention will now be further described, by way of example only, with reference to the accompanying figures in which:

FIG. 1 shows an example of a consumer electronic device incorporating a holographic projection module;

FIG. 2 shows an example of an optical system for the holographic projection module of FIG. 1;

FIG. 3 shows a block diagram of an embodiment of a hardware accelerator for the holographic image display system of FIGS. 1 and 2;

FIG. 4 shows the operations performed within an embodiment of a hardware block as shown in FIG. 3;

FIG. 5 shows the energy spectra of a sample image before and after multiplication by a random phase matrix.

FIG. 6 shows an embodiment of a hardware block with parallel quantisers for the simultaneous generation of two sub-frames from the real and imaginary components of the complex holographic sub-frame data respectively.

FIG. 7 shows an embodiment of hardware to generate pseudo-random binary phase data and multiply incoming image data, I_{xy}, by the phase values to produce G_{xy}.

FIG. 8 shows an embodiment of hardware to multiply incoming image frame data, I_{xy}, by complex phase values, which are randomly selected from a look-up table, to produce phase-modulated image data, G_{xy};

FIG. 9 shows an embodiment of hardware which performs a 2-D transform on incoming phase-modulated image data, G_{xy}, by means of a 1-D transform block with feedback, to produce holographic data gᵤᵥ;

FIG. 10 shows a colour holographic image projection system suitable for use with embodiments of the invention;

FIG. 11 shows the power spectral density of an unmodulated speckle pattern when imaging a uniform target through a square aperture of side L;

FIG. 12 shows an outline of the speckle model showing (a) an image of the phase randomised target image projected onto a rough screen (b) the far field generated by the screen, apertured by the anatomical pupil (c) the intensity image of the screen created on the retina, the central region of which (shown by box) is used to calculate the power spectral density (shown in (d));

FIG. 13 shows the effect on the structure of the speckle field when aperturing the far field to (a) 25% (b) 50% (c) 75% (d) 100% of the 5.3 mm anatomical pupil area;

FIG. 14 shows the modelled variation in the power spectral density (solid lines) for four different aperture sizes compared to the theoretical values (dashed lines) calculated from the aperture size alone;

FIG. 15 shows pixel value histograms for the four aperture sizes (a) 25% (b) 50% (c) 75% (d) 100% of the replay field area; plots showing an exponential decay in frequency with pixel value are shown using a red line; the speckle contrast values are 0.92, 0.90, 0.87, and 0.68 respectively;

FIG. 16 shows images showing the region of the screen covered by the aperture PSF for aperture sizes (a) 25% (b) 50% (c) 75% (d) 100%;

FIG. 17 shows aperturing the replay field to (a) 6.25% (b) 12.5% (c) 18.75% (d) 25% of the replay field size whilst maintaining the same resolution as the simulation used to create FIG. 15; the speckle contrast values are 0.69, 0.85, 0.86 and 0.89 respectively;

FIG. 18 shows the effect of aperturing the replay field to (a) 6.25% (b) 12.5% (c) 18.75% (d) 25% of the replay field size whilst increasing the resolution of the simulation by a factor of 4; the speckle contrast values are 0.92, 0.98, 0.97 and 0.98 respectively;

FIG. 19 shows the spectral power distributions calculated using a high resolution simulation for the aperture sizes 5%, 10%, 15% and 20% (solid lines); theoretical predictions for the spectral power distribution of the four different aperture sizes are shown by the dashed lines;

FIG. 20 shows histograms of the intensity patterns formed by an aberrated imaging system for aperture sizes of (a) 5% (b) 10% (c) 15% (d) 20%; the speckle contrast values were 0.92, 0.92, 0.97 and 0.97 respectively;

FIG. 21 shows spectral power distributions for the intensity patterns measured using an aberrated imaging system;

FIG. 22 shows the effect of a Luminit 75°×45° diffuser on the spectral properties of the speckle field—rotating the diffuser at speeds of 50, 100, 150 and 200 rps significantly reduces the power seen at the lowest spatial frequencies, producing a smoother image;

FIG. 23 shows change in the spectral power density using (blue) no diffuser (green) a static diffuser in the intermediate image plane and (red) a piezo electric actuator to vibrate a pixellated binary phase mask;

FIGS. 24a and 24b show, schematically, block diagrams of first and second examples of holographic image display systems implementing of embodiments of the invention; and

FIGS. 25a and 25b show, respectively, a schematic diagram of a colour holographic image display system embodying the invention, and details of a mechanical configuration for the system of FIG. 25a illustrating details of the diffuser and actuator.

### DETAILED DESCRIPTION OF THE PREFERRED EMBODIMENT

We have previously described, in UK patent application number 0512179.3 filed 15 Jun. 2005, incorporated in its entirety by reference herein, a holographic projection module comprising a substantially monochromatic light source such as a laser diode; a spatial light modulator (SLM) to (phase) modulate the light to provide a hologram for generating a displayed image; and a demagnifying optical system to increase the divergence of the modulated light to form the displayed image. Without the demagnifying optics the size (and distance from the SLM) of a displayed image depends on the pixel size of the SLM, smaller pixels diffracting the light more to produce a larger image. Typically an image would need to be viewed at a distance of several metres or more. The demagnifying optics increase the diffraction, thus allowing an image of a useful size to be displayed at a practical distance. Moreover the displayed image is substantially focus-free: that is the image is substantially in focus over a wide range or at all distances from the projection module.

A wide range of different optical arrangements can be used to achieve this effect but one particularly advantageous combination comprises first and second lenses with respective first and second focal lengths, the second focal length being shorter than the first and the first lens being closer to the spatial light modulator (along the optical path) than the second lens. Preferably the distance between the lenses is substantially equal to the sum of their focal distances, in effect forming a (demagnifying) telescope. In some embodiments two positive (i.e., converging) simple lenses are employed although in other embodiments one or more negative or diverging lenses may be employed. A filter may also be included to filter out unwanted parts of the displayed image, for example a bright (zero order) undiffracted spot or a repeated first order image (which may appear as an upside down version of the displayed image).

This optical system (and those described later) may be employed with any type of system or procedure for calculating a hologram to display on the SLM in order to generate the displayed image. However we have some particularly preferred procedures in which the displayed image is formed from a plurality of holographic sub-images which visually combine to give (to a human observer) the impression of the desired image for display. Thus, for example, these holographic sub-frames are preferably temporally displayed in rapid succession so as to be integrated within the human eye. The data for successive holographic sub-frames may be generated by a digital signal processor, which may comprise either a general purpose DSP under software control, for example in association with a program stored in non-volatile memory, or dedicated hardware, or a combination of the two such as software with dedicated hardware acceleration. Preferably the SLM comprises a reflective SLM (for compactness) but in general any type of pixellated microdisplay which is able to phase modulate light may be employed, optionally in association with an appropriate driver chip if needed.

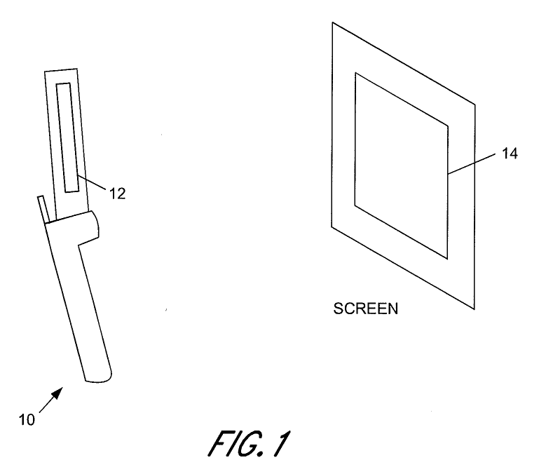

Referring now to FIG. 1, this shows an example a consumer electronic device 10 incorporating a hardware projection module 12 to project a displayed image 14. Displayed image 14 comprises a plurality of holographically generated sub-images each of the same spatial extent as displayed image 14, and displayed rapidly in succession so as to give the appearance of the displayed image. Each holographic sub-frame is generated along the lines described below. For further details reference may be made to GB 0329012.9 (ibid).

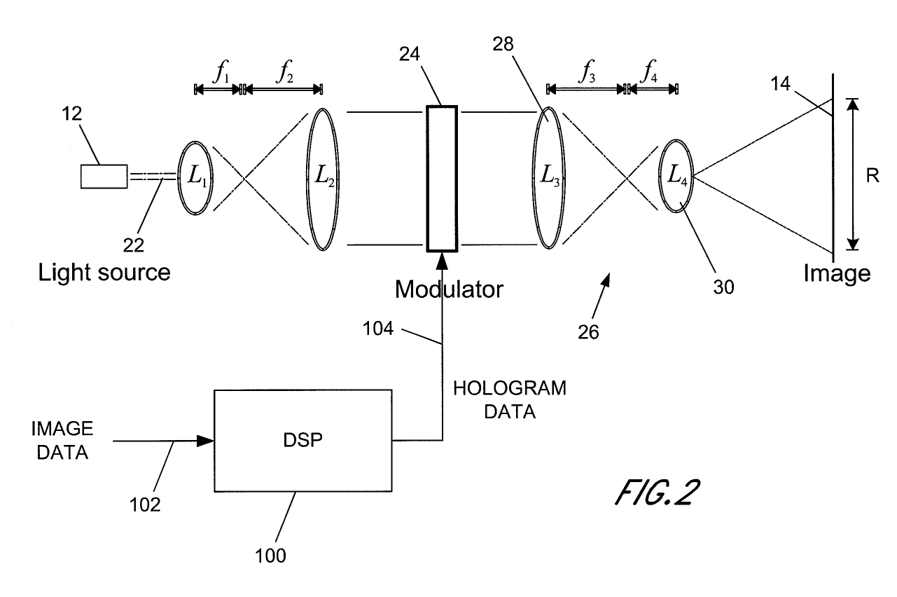

FIG. 2 shows an example optical system for the holographic projection module of FIG. 1. Referring to FIG. 2, a laser diode 20 (for example, at 532 nm), provides substantially collimated light 22 to a spatial light modulator 24 such as a pixellated liquid crystal modulator. The SLM 24 phase modulates light 22 with a hologram and the phase modulated light is provided a demagnifying optical system 26. In the illustrated embodiment, optical system 26 comprises a pair of lenses 28, 30 and increases the size of the projected holographic image by diverging the light forming the displayed image, as shown.

Still referring to FIG. 2, in more detail lenses L₁ and L₂ (with focal lengths f₁ and f₂ respectively) form the beam-expansion pair. This expands the beam from the light source so that it covers the whole surface of the modulator; depending on the relative size of the beam 22 and SLM 24 these may be omitted.

Lens pair L₃ and L₄ (with focal lengths f₃ and f₄ respectively) form a demagnification lens pair. This effectively reduces the pixel size of the modulator, thus increasing the diffraction angle. As a result, the image size increases. The increase in image size is equal to the ratio of f₃ to f₄, which are the focal lengths of lenses L₃ and L₄ respectively. A spatial filter may be included to filter out unwanted parts of the displayed image, for example a zero order undiffracted spot or a repeated first order (conjugate) image, which may appear as an upside down version of the displayed image, depending upon how the hologram for displaying the image is generated.

Continuing to refer to FIG. 2, a digital signal processor 100 has an input 102 to receive image data from the consumer electronic device defining the image to be displayed. The DSP 100 implements a procedure (described below) to generate phase hologram data for a plurality of holographic sub-frames which is provided from an output 104 of the DSP 100 to the SLM 24, optionally via a driver integrated circuit if needed. The DSP 100 drives SLM 24 to project a plurality of phase hologram sub-frames which combine to give the impression of displayed image 14 in the replay field (RPF).

The DSP 100 may comprise dedicated hardware and/or Flash or other read-only memory storing processor control code to implement a hologram generation procedure, in preferred embodiments in order to generate sub-frame phase hologram data for output to the SLM 24.

### OSPR

We now describe a preferred procedure for calculating hologram data for display on SLM 24. We refer to this procedure, in broad terms, as One Step Phase Retrieval (OSPR), although strictly speaking in some implementations it could be considered that more than one step is employed (as described for example in GB0518912.1 and GB0601481.5, incorporated in their entirety by reference herein, where “noise” in one sub-frame is compensated in a subsequent sub-frame).

Thus we have previously described, in UK Patent Application No. GB0329012.9, filed 15 Dec. 2003, a method of displaying a holographically generated video image comprising plural video frames, the method comprising providing for each frame period a respective sequential plurality of holograms and displaying the holograms of the plural video frames for viewing the replay field thereof, whereby the noise variance of each frame is perceived as attenuated by averaging across the plurality of holograms.

Broadly speaking in our preferred method the SLM is modulated with holographic data approximating a hologram of the image to be displayed. However this holographic data is chosen in a special way, the displayed image being made up of a plurality of temporal sub-frames, each generated by modulating the SLM with a respective sub-frame hologram. These sub-frames are displayed successively and sufficiently fast that in the eye of a (human) observer the sub-frames (each of which have the spatial extent of the displayed image) are integrated together to create the desired image for display.

Each of the sub-frame holograms may itself be relatively noisy, for example as a result of quantising the holographic data into two (binary) or more phases, but temporal averaging amongst the sub-frames reduces the perceived level of noise. Embodiments of such a system can provide visually high quality displays even though each sub-frame, were it to be viewed separately, would appear relatively noisy.

A scheme such as this has the advantage of reduced computational requirements compared with schemes which attempt to accurately reproduce a displayed image using a single hologram, and also facilitate the use of a relatively inexpensive SLM.

Here it will be understood that the SLM will, in general, provide phase rather than amplitude modulation, for example a binary device providing relative phase shifts of zero and π (+1 and −1 for a normalised amplitude of unity). In preferred embodiments, however, more than two phase levels are employed, for example four phase modulation (zero, π/2, π, 3π/2), since with only binary modulation the hologram results in a pair of images one spatially inverted in respect to the other, losing half the available light, whereas with multi-level phase modulation where the number of phase levels is greater than two this second image can be removed. Further details can be found in our earlier application GB0329012.9 (ibid), hereby incorporated by reference in its entirety.

Although embodiments of the method are computationally less intensive than previous holographic display methods it is nonetheless generally desirable to provide a system with reduced cost and/or power consumption and/or increased performance. It is particularly desirable to provide improvements in systems for video use which generally have a requirement for processing data to display each of a succession of image frames within a limited frame period.

We have also described, in GB0511962.3, filed 14 Jun. 2005, a hardware accelerator for a holographic image display system, the image display system being configured to generate a displayed image using a plurality of holographically generated temporal sub-frames, said temporal sub-frames being displayed sequentially in time such that they are perceived as a single reduced-noise image, each said sub-frame being generated holographically by modulation of a spatial light modulator with holographic data such that replay of a hologram defined by said holographic data defines a said sub-frame, the hardware accelerator comprising: an input buffer to store image data defining said displayed image; an output buffer to store holographic data for a said sub-frame; at least one hardware data processing module coupled to said input data buffer and to said output data buffer to process said image data to generate said holographic data for a said sub-frame; and a controller coupled to said at least one hardware data processing module to control said at least one data processing module to provide holographic data for a plurality of said sub-frames corresponding to image data for a single said displayed image to said output data buffer.

In this preferably a plurality of the hardware data processing modules is included for processing data for a plurality of the sub-frames in parallel. In preferred embodiments the hardware data processing module comprises a phase modulator coupled to the input data buffer and having a phase modulation data input to modulate phases of pixels of the image in response to an input which preferably comprises at least partially random phase data. This data may be generated on the fly or provided from a non-volatile data store. The phase modulator preferably includes at least one multiplier to multiply pixel data from the input data buffer by input phase modulation data. In a simple embodiment the multiplier simply changes a sign of the input data.

An output of the phase modulator is provided to a space-frequency transformation module such as a Fourier transform or inverse Fourier transform module. In the context of the holographic sub-frame generation procedure described later these two operations are substantially equivalent, effectively differing only by a scale factor. In other embodiments other space-frequency transformations may be employed (generally frequency referring to spatial frequency data derived from spatial position or pixel image data). In some preferred embodiments the space-frequency transformation module comprises a one-dimensional Fourier transformation module with feedback to perform a two-dimensional Fourier transform of the (spatial distribution of the) phase modulated image data to output holographic sub-frame data. This simplifies the hardware and enables processing of, for example, first rows then columns (or vice versa).

In preferred embodiments the hardware also includes a quantiser coupled to the output of the transformation module to quantise the holographic sub-frame data to provide holographic data for a sub-frame for the output buffer. The quantiser may quantise into two, four or more (phase) levels. In preferred embodiments the quantiser is configured to quantise real and imaginary components of the holographic sub-frame data to generate a pair of sub-frames for the output buffer. Thus in general the output of the space-frequency transformation module comprises a plurality of data points over the complex plane and this may be thresholded (quantised) at a point on the real axis (say zero) to split the complex plane into two halves and hence generate a first set of binary quantised data, and then quantised at a point on the imaginary axis, say 0j, to divide the complex plane into a further two regions (complex component greater than 0, complex component less than 0). Since the greater the number of sub-frames the less the overall noise this provides further benefits.

Preferably one or both of the input and output buffers comprise dual-ported memory. In some particularly preferred embodiments the holographic image display system comprises a video image display system and the displayed image comprises a video frame.

In an embodiment, the various stages of the hardware accelerator implement a variant of the algorithm given below, as described later. The algorithm is a method of generating, for each still or video frame I=I_{xy}, sets of N binary-phase holograms h⁽¹⁾ . . . h^{(N)}. Statistical analysis of the algorithm has shown that such sets of holograms form replay fields that exhibit mutually independent additive noise.

1. Let G_{xy}⁽ⁿ⁾=I_{xy}exp(jφ_{xy}⁽ⁿ⁾) where φ_{xy}⁽ⁿ⁾ is uniformly distributed between 0 and 2π for 1≦n≦N/2 and 1≦x,y≦m

2. Let gᵤᵥ⁽ⁿ⁾=F⁻¹[G_{xy}⁽ⁿ⁾] where F⁻¹ represents the two-dimensional inverse Fourier transform operator, for 1≦n≦N/2

3. Let mᵤᵥ⁽ⁿ⁾ [symbol] {gᵤᵥ⁽ⁿ⁾} for 1≦n≦N/2

4. Let mᵤᵥ^{(n+N/2)}=ℑ{gᵤᵥ⁽ⁿ⁾} for 1≦n≦N/2

5. Let

$${h}_{uv}^{( n )} = \{ \begin{matrix}- 1 if {m}_{uv}^{( n )} < {Q}^{( n )} \\ + 1 if {m}_{uv}^{( n )} \geq {Q}^{( n )}\end{matrix}$$

where Q⁽ⁿ⁾=median (mᵤᵥ⁽ⁿ⁾) and 1≦n≦N.

Step 1 forms N targets G_{xy}⁽ⁿ⁾ equal to the amplitude of the supplied intensity target I_{xy}, but with independent identically-distributed (i.i.t.), uniformly-random phase. Step 2 computes the N corresponding full complex Fourier transform holograms gᵤᵥ⁽ⁿ⁾. Steps 3 and 4 compute the real part and imaginary part of the holograms, respectively. Binarisation of each of the real and imaginary parts of the holograms is then performed in step 5: thresholding around the median of mᵤᵥ⁽ⁿ⁾ ensures equal numbers of −1 and 1 points are present in the holograms, achieving DC balance (by definition) and also minimal reconstruction error. In an embodiment, the median value of mᵤᵥ⁽ⁿ⁾ is assumed to be zero. This assumption can be shown to be valid and the effects of making this assumption are minimal with regard to perceived image quality. Further details can be found in the applicant's earlier application (ibid), to which reference may be made.

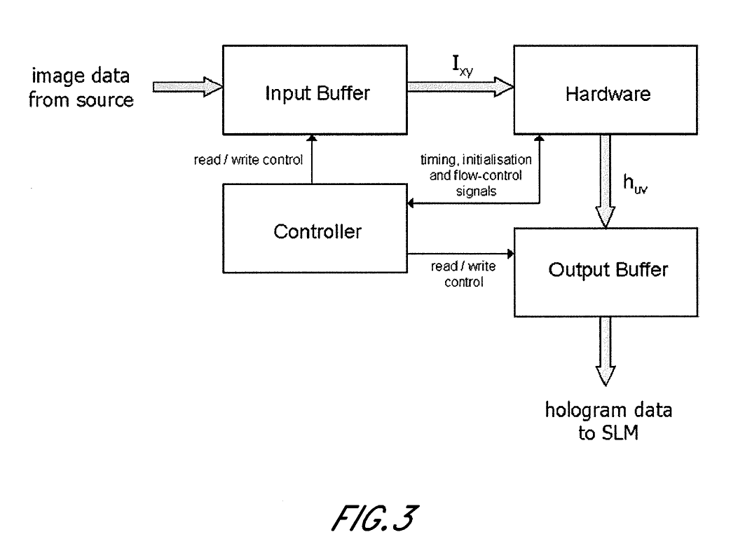

FIG. 3 shows a block diagram of an embodiment of a hardware accelerator for the holographic image display system of the module 12 of FIG. 1. The input to the system is preferably image data from a source such as a computer, although other sources are equally applicable. The input data is temporarily stored in one or more input buffer, with control signals for this process being supplied from one or more controller units within the system. Each input buffer preferably comprises dual-port memory such that data is written into the input buffer and read out from the input buffer simultaneously. The output from the input buffer shown in FIG. 1 is an image frame, labelled I, and this becomes the input to the hardware block. The hardware block, which is described in more detail using FIG. 2, performs a series of operations on each of the aforementioned image frames, I, and for each one produces one or more holographic sub-frames, h, which are sent to one or more output buffer. Each output buffer preferably comprises dual-port memory. Such sub-frames are outputted from the aforementioned output buffer and supplied to a display device, such as a SLM, optionally via a driver chip. The control signals by which this process is controlled are supplied from one or more controller unit. The control signals preferably ensure that one or more holographic sub-frames are produced and sent to the SLM per video frame period. In an embodiment, the control signals transmitted from the controller to both the input and output buffers are read/write select signals, whilst the signals between the controller and the hardware block comprise various timing, initialisation and flow-control information.

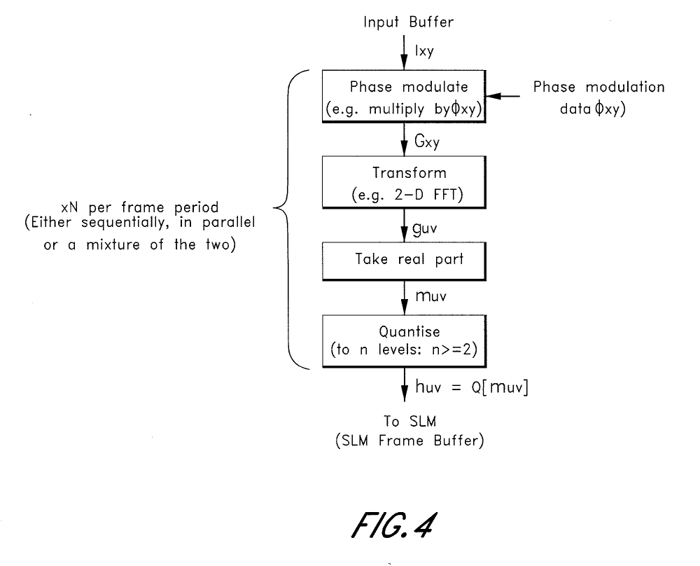

FIG. 4 shows an embodiment of a hardware block as described in FIG. 3, comprising a set of hardware elements designed to generate one or more holographic sub-frames for each image frame that is supplied to the block. In such an embodiment, preferably one image frame, I_{xy}, is supplied one or more times per video frame period as an input to the hardware block. The source of such image frames may be one or more input buffers as shown in FIG. 3. Each image frame, I_{xy}, is then used to produce one or more holographic sub-frames by means of a set of operations comprising one or more of: a phase modulation stage, a space-frequency transformation stage and a quantisation stage. In embodiments, a set of N sub-frames, where N is greater than or equal to one, is generated per frame period by means of using either one sequential set of the aforementioned operations, or a several sets of such operations acting in parallel on different sub-frames, or a mixture of these two approaches.

The purpose of the phase-modulation block shown in the embodiment of FIG. 4 is to redistribute the energy of the input frame in the spatial-frequency domain, such that improvements in final image quality are obtained after performing later operations.

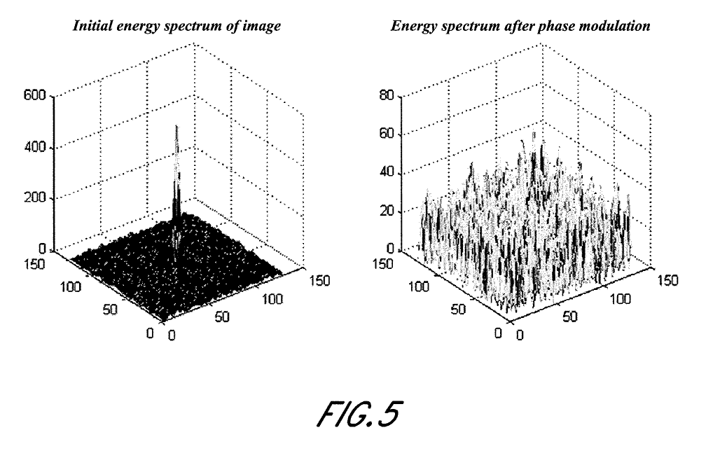

FIG. 5 shows an example of how the energy of a sample image is distributed before and after a phase-modulation stage in which a random phase distribution is used. It can be seen that modulating an image by such a phase distribution has the effect of redistributing the energy more evenly throughout the spatial-frequency domain.

The quantisation hardware that is shown in the embodiment of FIG. 4 has the purpose of taking complex hologram data, which is produced as the output of the preceding space-frequency transform block, and mapping it to a restricted set of values, which correspond to actual phase modulation levels that can be achieved on a target SLM. In an embodiment, the number of quantisation levels is set at two, with an example of such a scheme being a phase modulator producing phase retardations of 0 or π at each pixel. In other embodiments, the number of quantisation levels, corresponding to different phase retardations, may be two or greater. There is no restriction on how the different phase retardations levels are distributed—either a regular distribution, irregular distribution or a mixture of the two may be used. In preferred embodiments the quantiser is configured to quantise real and imaginary components of the holographic sub-frame data to generate a pair of sub-frames for the output buffer, each with two phase-retardation levels. It can be shown that for discretely pixellated fields, the real and imaginary components of the complex holographic sub-frame data are uncorrelated, which is why it is valid to treat the real and imaginary components independently and produce two uncorrelated holographic sub-frames.

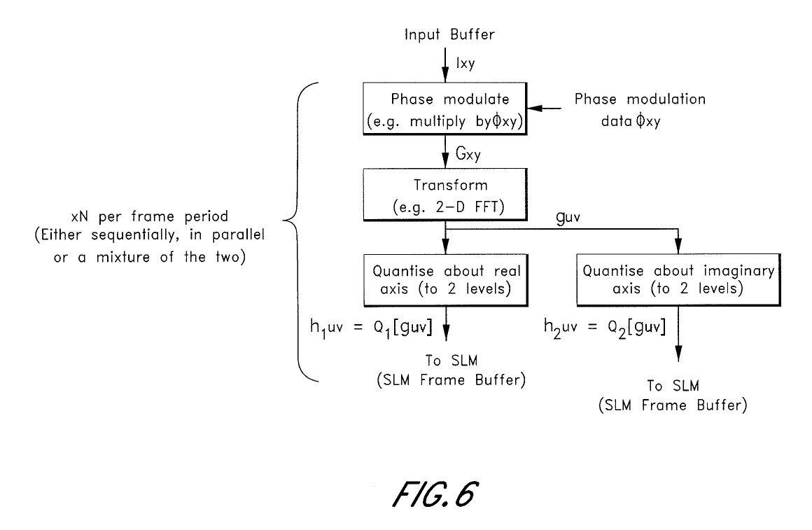

FIG. 6 shows an embodiment of the hardware block described in FIG. 3 in which a pair of quantisation elements are arranged in parallel in the system so as to generate a pair of holographic sub-frames from the real and imaginary components of the complex holographic sub-frame data respectively.

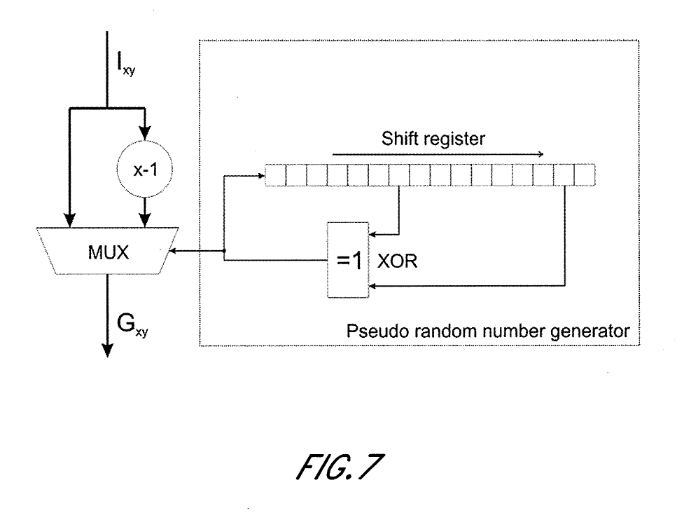

There are many different ways in which phase-modulation data, as shown in FIG. 4, may be produced. In an embodiment, pseudo-random binary-phase modulation data is generated by hardware comprising a shift register with feedback and an XOR logic gate. FIG. 7 shows such an embodiment, which also includes hardware to multiply incoming image data by the binary phase data. This hardware comprises means to produce two copies of the incoming data, one of which is multiplied by −1, followed by a multiplexer to select one of the two data copies. The control signal to the multiplexer in this embodiment is the pseudo-random binary-phase modulation data that is produced by the shift-register and associated circuitry, as described previously.

In another embodiment, pre-calculated phase modulation data is stored in a look-up table and a sequence of address values for the look-up table is produced, such that the phase-data read out from the look-up table is random. In this embodiment, it can be shown that a sufficient condition to ensure randomness is that the number of entries in the look-up table, N, is greater than the value, m, by which the address value increases each time, that m is not an integer factor of N, and that the address values ‘wrap around’ to the start of their range when N is exceeded. In a preferred embodiment, N is a power of 2, e.g. 256, such that address wrap around is obtained without any additional circuitry, and m is an odd number such that it is not a factor of N.

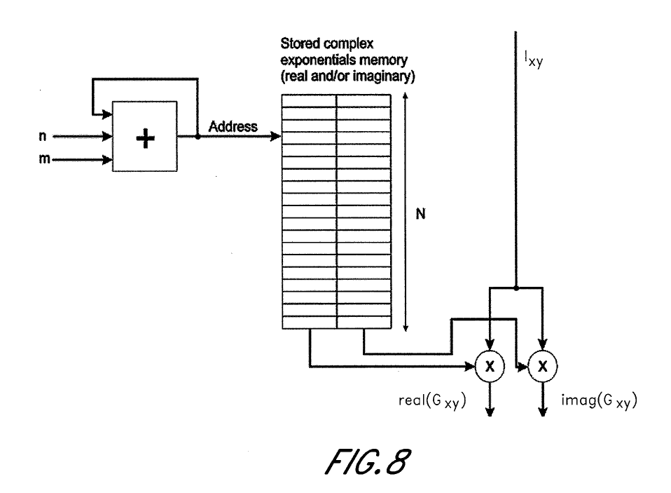

FIG. 8 shows suitable hardware for such an embodiment, comprising a three-input adder with feedback, which produces a sequence of address values for a look-up table containing a set of N data words, each comprising a real and imaginary component. Input image data, I_{xy}, is replicated to form two identical signals, which are multiplied by the real and imaginary components of the selected value from the look-up table. This operation thereby produces the real and imaginary components of the phase-modulated input image data, G_{xy}, respectively. In an embodiment, the third input to the adder, denoted n, is a value representing the current holographic sub-frame. In another embodiment, the third input, n, is omitted. In a further embodiment, m and N are both be chosen to be distinct members of the set of prime numbers, which is a strong condition guaranteeing that the sequence of address values is truly random.

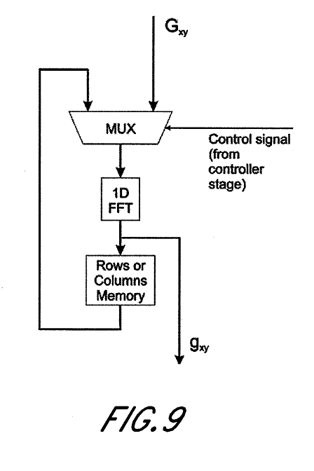

FIG. 9 shows an embodiment of hardware which performs a 2-D FFT on incoming phase-modulated image data, G_{xy}, as shown in FIG. 4. In this embodiment, the hardware to perform the 2-D FFT operation comprises a 1-D FFT block, a memory element for storing intermediate row or column results, and a feedback path from the output of the memory to one input of a multiplexer. The other input of this multiplexer is the phase-modulated input image data, G_{xy}, and the control signal to the multiplexer is supplied from a controller block as shown in FIG. 4. Such an embodiment represents an area-efficient method of performing a 2-D FFT operation.

In other implementations the operations illustrated in FIGS. 4 and/or 6 may be implemented partially or wholly in software, for example on a general purpose digital signal processor.

In the OSPR approach we have described above subframe holograms are generated independently and thus exhibit independent noise. However the generation process for each subframe can take into account the noise generated by the previous subframes in order to cancel it out, effectively “feeding back” the perceived image formed after, say, n OSPR frames to stage n+1 of the procedure, forming a closed-loop system. Such an adaptive (AD) OSPR procedure uses feedback as follows: each stage n of the algorithm calculates the noise resulting from the previously-generated holograms H₁ to Hₙ₋₁, and factors this noise into the generation of the hologram Hₙ to cancel it out. As a result, noise variance falls as 1/N² (where a target image T outputs a set of N holograms). More details can be found in WO2007/031797 and WO2007/085874.

### Lens Encoding

The OSPR algorithm can be generalised to the case of calculating Fresnel holograms by replacing the Fourier transform step by a discrete Fresnel transform. One significant advantage associated with binary Fresnel holograms is that the diffracted near-field does not contain a conjugate image.

Referring back to FIG. 2, this shows a simple optical architecture for a holographic projector. The lens pair L₁ and L₂ form a Keplerian telescope or beam expander, which expands the laser beam to capture the entire hologram surface, so that low-pass filtering of the replay field does not result. The reverse arrangement is used for the lens pair L₃ and L₄ effectively demagnifying the hologram and consequently increasing the diffraction angle. The resultant increase in the replay field size R is the “demagnification” of the system, and is set by the ratio of focal lengths f₄ to f₃.

It is possible to remove the lens L₃ from the optical system by employing a Fresnel hologram which encodes the equivalent lens power. The output image from the projector would still be in-focus at all distances from the output lens L₄ but due to the characteristics of near-field propagation, is free from the conjugate image artifact. L₃ is the larger of the lens pair, as it has the longer focal length, and removing it from the optical path significantly reduces the size and weight of the system.

The same technique can also be applied to the beam-expansion lens pair L₁ and L₂, which perform the reverse function to the pair L₃ and L₄. It is therefore possible to share a lens between the beam-expansion and demagnification assemblies, which can be represented as lens function encoded onto a Fresnel hologram. This results in a holographic projector which requires only two small, short focal length lenses. The remaining lenses are encoded onto a hologram, which is used in a reflective configuration.

Referring back to steps 1 to 5 of the above-described OSPR procedure, step 2 was previously a two-dimensional inverse Fourier transform. To implement a Fresnel hologram, also encoding a lens, as described above an inverse Fresnel transform is employed in place of the previously described inverse Fourier transform.

The discrete Fresnel transform can be expressed in terms of a Fourier transform

H_{xy}=F_{xy}⁽¹⁾·F[Fᵤᵥ⁽²⁾hᵤᵥ]

The inverse Fresnel transform may take the form:

$$\frac{{F}^{- 1} [ \frac{{H}_{xy}}{{F}_{xy}^{( 1 )}} ]}{{F}_{uv}^{( 2 )}}$$

$$where$$

$${F}_{xy}^{( 1 )} = \frac{{Δ}_{x} {Δ}_{y}}{j λ z} exp \frac{j 2 π z}{λ} exp \frac{j π}{λ z} [ {( \frac{x}{N {Δ}_{x}} )}^{2} + {( \frac{y}{M {Δ}_{y}} )}^{2} ]$$

$$and$$

$${F}_{uv}^{( 2 )} = exp \frac{j π}{λ z} ( {u}^{2} {Δ}_{x} + {v}^{2} {Δ}_{y} ) .$$

In effect the factors F⁽¹⁾ and F⁽²⁾ turn the Fourier transform in a Fresnel transform of the hologram h. The size of each hologram pixel is Δₓ×Δ_{y}, and the total size of the hologram is (in pixels) N×M. In the above, z defines the focal length of the holographic lens. Finally, the sample spacing in the replay field is:

$${Δ}_{u} = \frac{λ z}{N {Δ}_{x}}$$

$${Δ}_{v} = \frac{λ z}{N {Δ}_{y}}$$

so that the dimensions of the replay field are

$$\frac{λ z}{{Δ}_{x}} \times \frac{λ z}{{Δ}_{y}} ,$$

consistent with the size of replay field in the Fraunhofer diffraction regime.

The transform shown in FIG. 4 may be a two-dimensional inverse Fresnel transform (rather than a two-dimensional FFT) and, likewise the transform in FIG. 6 may be a Fresnel (rather than a Fourier) transform. In the hardware of FIG. 9 the one-dimensional FFT block may be replaced by an FRT (Fresnel transform) block so that the hardware of FIG. 9 performs a two-dimensional FRT rather than a two-dimensional FFT. Further because of the scale factors F_{xy}, and Fᵤᵥ mentioned above, one scale factor is preferably incorporated within the loop shown in FIG. 9 and a second multiplies the result.

For more details reference may be made to the applicant's co-pending international patent application number PCT/GB2007/050157 filed 27 Mar. 2007, hereby incorporated by reference in its entirety.

### Colour Displays

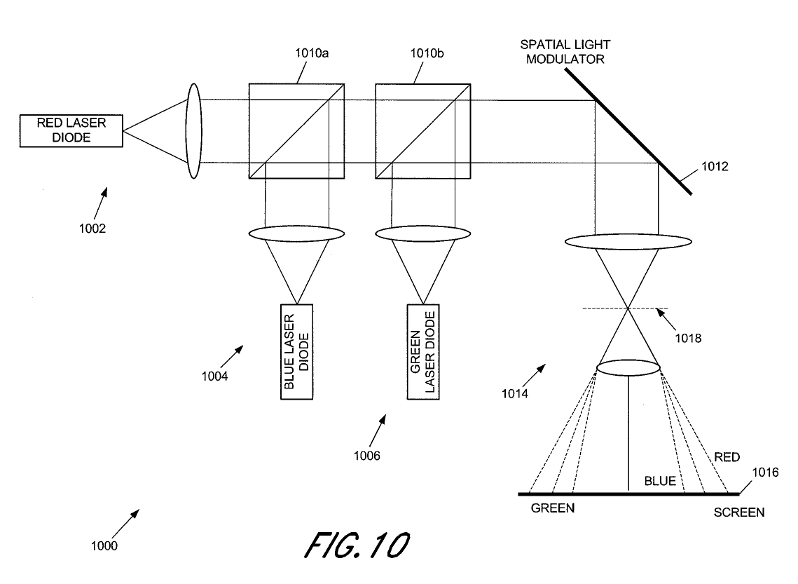

Referring to FIG. 10, this shows a colour holographic image projection system 1000 according to an embodiment of the invention.

The system 1000 comprises red 1002, green 1006, and blue 1004 collimated laser diode light sources, for example at respective wavelengths of 638 nm, 532 nm and 445 nm. Each light source comprises a laser diode 1002 and, if necessary, a collimating lens and/or beam expander. Optionally the respective sizes of the beams are scaled to the respective sizes of the holograms, as described later. The red, green and blue light beams are combined in two dichroic beam splitters 1010a, b, as shown and the combined beam is provided to a reflective spatial light modulator 1012 (although in other embodiments a transmissive SLM may be employed).

The combined optical beam is provided to demagnification optics 1014 which project the holographically generated image onto a screen 1016. As illustrated, the extent of the red field is greater than that of the blue field, determined by the (constant) SLM pixel pitch and the respective wavelengths of the illuminating light. In operation red, green and blue fields are time multiplexed, for example by driving the laser diodes in a time-multiplexed manner, to create a full colour display.

Theoretically the demagnifying optics 1014 could be configured to demagnify by different factors for different wavelengths by, in effect, introducing controlled “chromatic” aberration. Alternatively the lens power may be adjusted in accordance with the colour of light illuminating the SLM, to select different demagnifications in synchrony with the different colours of the SLM. Preferably, however, adjustment for the different degrees of diffraction of the different colours of light by the SLM is compensated for when calculating the hologram that is to be displayed on the SLM, as described in detail in PCT/GB2007/050291, hereby incorporated by reference.

The dashed line 1018 shows an intermediate image plane, that is a fourier transform plane of the SLM, at which a speckle-reducing diffuser (described below) may be located.

### Speckle Reduction—Theory, Modelling and Experiment

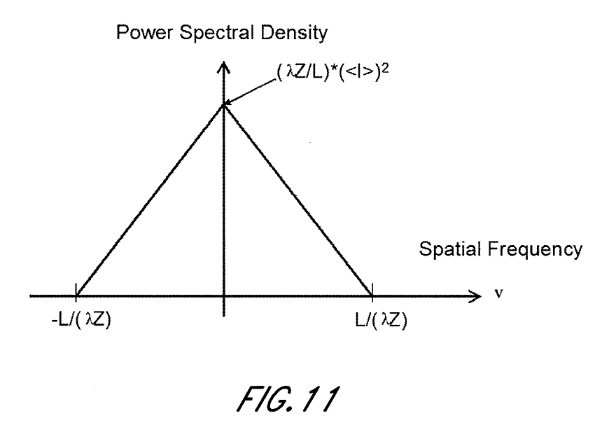

For a static viewer position, the apparent structure size of the speckle field will depend upon the resolution limit (and hence pupil size) of the imaging system used. Following the theoretical analysis described in “Statistical Optics” (J. W. Goodman, Wiley Classics Library Edition, 2000) we assume that the scattering screen is ideal (i.e. a flat [−π, π] phase distribution) on scales approximating a wavelength. The spectral distribution of the speckle pattern is then given by the autocorrelation function of the aperture. For the case of a square pupil, this looks like the function seen in FIG. 11. For a circular aperture, the function falls off more gradually. This again shows that as the viewer pupil size decreases (decreasing L) the power spectral density becomes more constricted around the lowest spatial frequencies, leading to an apparent increase in the speckle size and a greater distraction to the viewer.

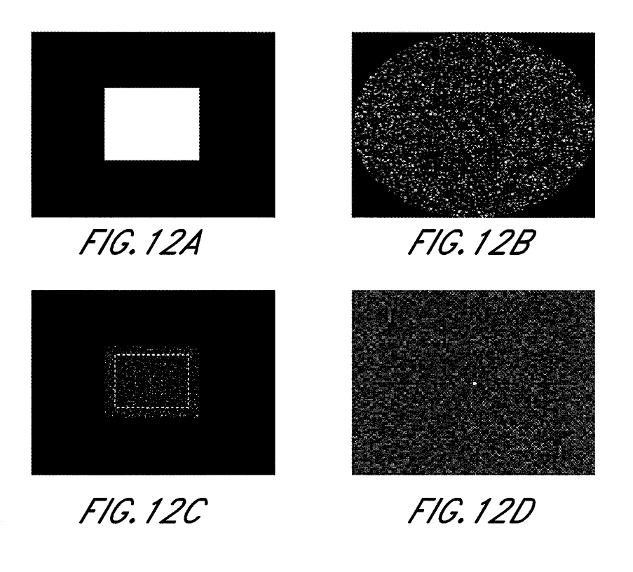

The effect of the pupil size on the speckle field can be determined within the model. Here the screen is modelled as an ideal scatterer with a pixel size of 20 μm across a 100×100 pixel area in a 256×256 pixel scene (FIG. 12(a)). By embedding the screen in zeros it should then be possible to discern the statistics of the speckle in the image from any background noise. This screen is phase modulated by the light from the projector. Assuming a 400×200 resolution and a 20° throw angle gives a pixel resolution of ˜140 μm at a distance of 20 cm. Assuming an angular resolution of 1 arcmin for the human eye, the smallest resolvable feature on the screen is then 60 μm.

By selecting a structure size of 20 μm for the screen, the physical size of the replay field is then f(=20 cm)*λ(=532 nm)/Δ(˜20 μm)˜5.3 mm across which is approximately the size of the anatomical pupil in dim viewing conditions (typically 5-8 mm). This replay field can then be apertured by a circular pupil to approximate the light passing through the eye (FIG. 12(b)). In real eyes, the imaging system is far from ideal. To make the simulation more realistic, aberrations taken from a data set of measured ocular aberrations can then be applied across the area of the anatomical pupil. In theory, the aberrations will not change the statistics of the speckle pattern observed, but they will change the exact distribution of the light in the image formed on the retina.

For a screen size of 2 mm×2 mm, and an ocular focal length of ˜17 mm, the magnification of the image will be around 17 mm/200 mm ˜ 1/12, leading to a total image size of 167 μm×167 μm. Given that the typical size of a cone photoreceptor in the eye is around 2.5 μm near the fovea, with a spacing of ˜3 μm the 200×200 pixels in the retinal image would have to be coherently downsampled to around 50×50 pixels. This means that groups of 4×4 pixels in the replay field will have to be summed coherently to determine the intensity and phase of the light incident upon each of the cones in the eye. This effect was not taken into consideration for the first set of simulations which assumed that the image was being taken with a camera of longer focal length and finer pixel resolution than the eye (FIG. 12(c)).

To avoid the edge distortion caused by the aberrations in the pupil plane, the retinal image of the screen was cropped to 80% in the x and y dimensions before determining the statistics of the intensity pattern observed (FIG. 12(d)).

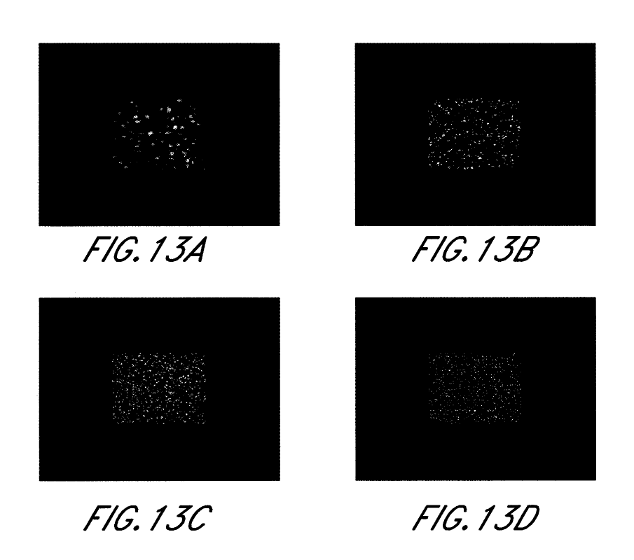

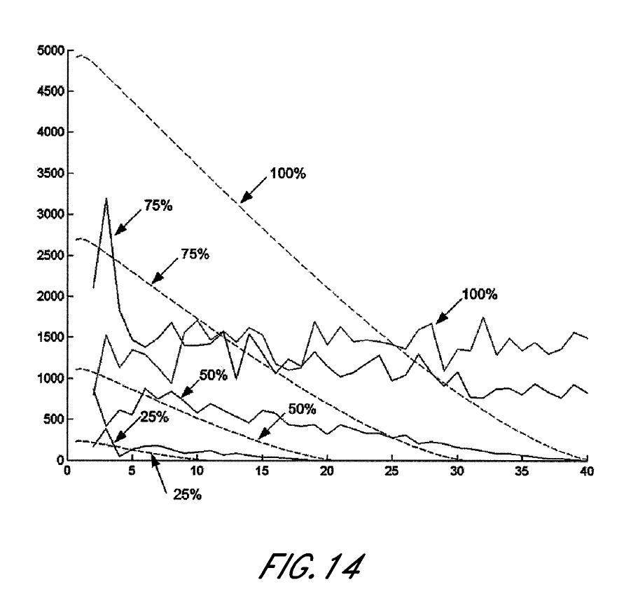

Testing the model: One of the primary tests to determine whether the intensity pattern predicted by the model was actually caused by a speckle effect was to compare the spectral properties of the intensity distribution to that predicted by theory. To test this, four different aperture sizes were used which filled 25%, 50%, 75% and 100% of the width of the replay field area. Smaller aperture sizes produced retinal images with coarser intensity patterns, in accordance with that observed in experiment and in theory (FIG. 13). The power spectral density of these intensity patterns were then calculated using an FFT on the apertured retinal (intensity) images. Because of the symmetry of repeated FFTs, this operation should then lead to a distribution spectral power that approximates the aperture function. To generate a power spectrum plot from a circular 2D spectral distribution, the 2D matrix was mapped to a polar coordinate system with the average power measured across all polar coordinates for each radius. As this mapping is a poor one, the resultant curves appear quite noisy. These curves are shown together with the simulated power spectra in FIG. 14. It can be seen that the best fit is obtained for the smallest aperture sizes; the reason for this is discussed below.

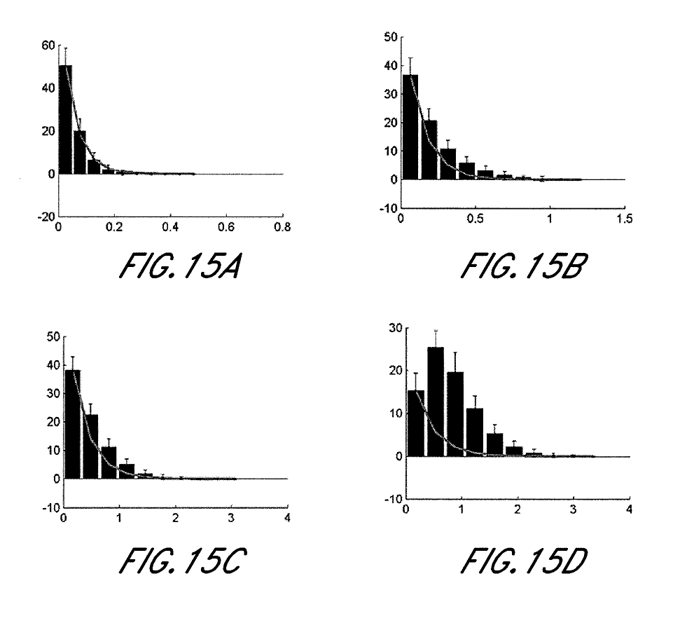

Further tests to determine whether the intensity pattern seen is indeed that due to coherent noise include measuring the speckle contrast and the population statistics of the intensity patterns. In theory, the ratio of the standard deviation to the mean intensity should be unity for a true speckle pattern. For the above simulations, the speckle contrast values for the different aperture sizes were (25%) 0.92, (50%) 0.90 (75%) 0.87, (100%) 0.68. The variation in the pixel value histograms are as shown in FIG. 15. Once again these show that the fit with the model is most accurate for the case of the smallest aperture size.

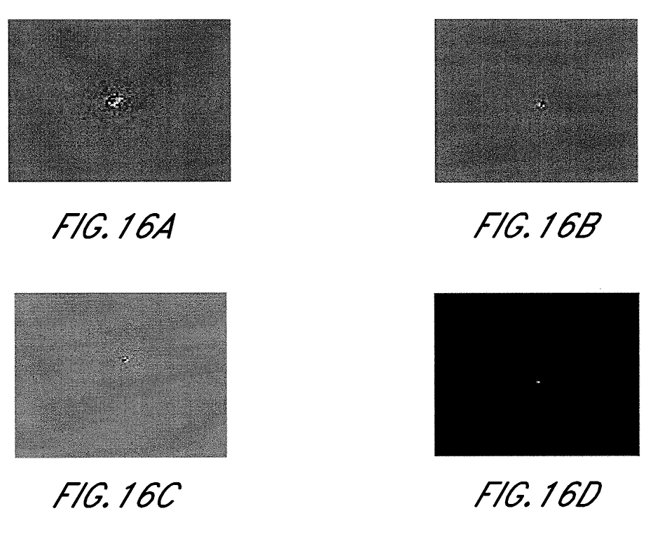

The reason for the increasing deviation of the simulations from the ideal speckle characteristics with aperture size can be explained in terms of the aperture PSF. In order to be truly simulating speckle, we require that each pixel in the image plane is the result of contributions from multiple pixels in the object plane. As the image plane can be described as the convolution of the image with the PSF of the aperture, the PSF must be sufficiently wide to contain multiple pixels within the PSF area. From FIG. 16 it can be seen that this is only really the case for aperture sizes of 25% and below.

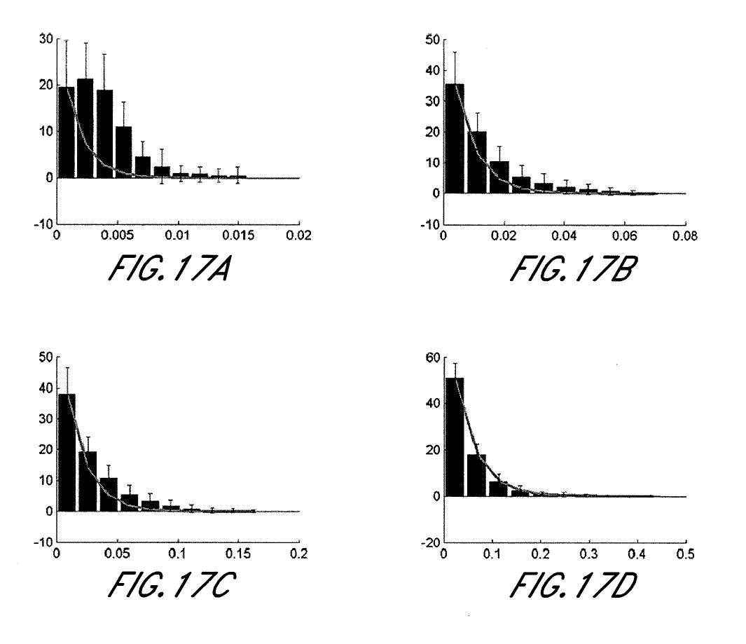

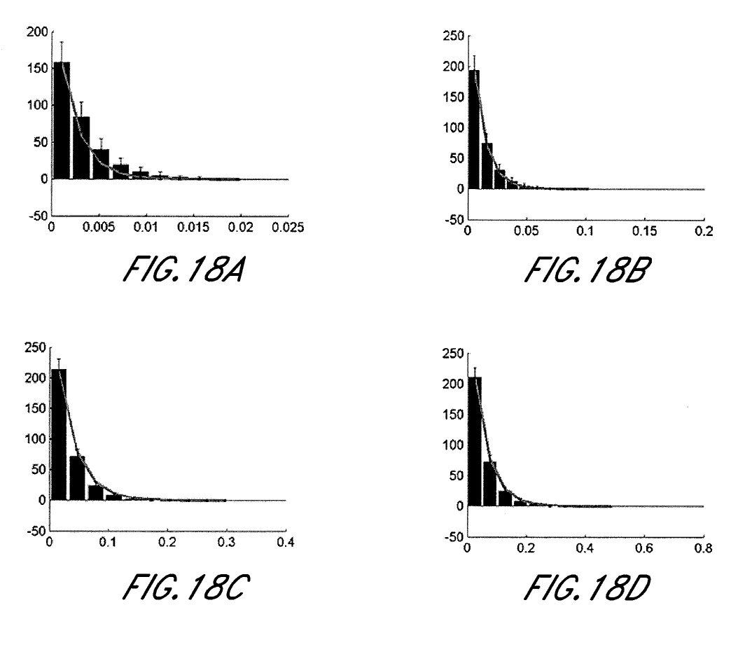

From this we can conclude that in order to obtain a realistic simulation of speckle, we require that the aperture occupies <25% of the replay field area, but in order for this area to correspond with a dimension of 5.3 mm, we require that the structure size of the screen falls by a factor of at least 4 to around 5 μm, i.e. we quadruple the resolution of the simulation. The alternative is to keep the simulation resolution the same and reduce the physical size of the screen by a factor of four in each dimension (0.25 mm²). However, in this case, after applying the aperture we rely on increasingly fewer data points in the simulation to construct the image plane from, leading to errors. This can be seen be reducing the aperture sizes by a factor of 4 and maintaining the same resolution (FIG. 17). By increasing the resolution of the simulation by the same factor that the aperture was decreased (so that the number of pixels used to compose the image plane remains constant) returns the intensity map to speckle statistics (FIG. 18). These values show that at a higher resolution, the simulation produces exponential decaying aberrations with contrast values around 0.9-1.1 when the aperture occupies ˜10% of the replay field area.

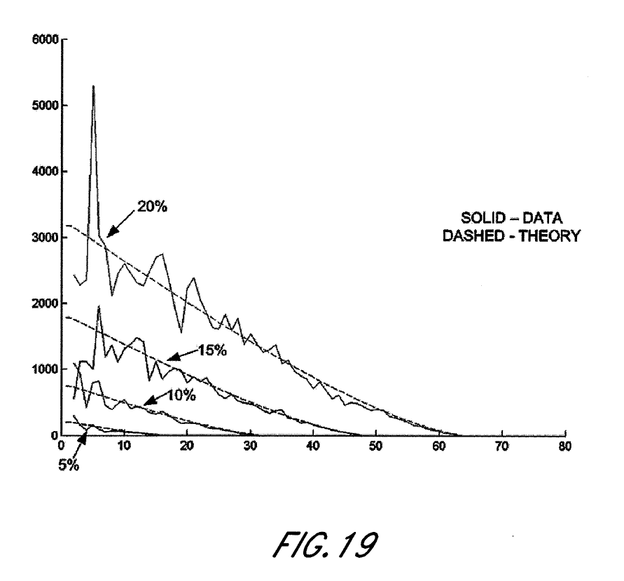

Calculating the spectral power distributions for the intensity field using these simulation parameters shows how close the model fits with theoretical predictions (FIG. 19).

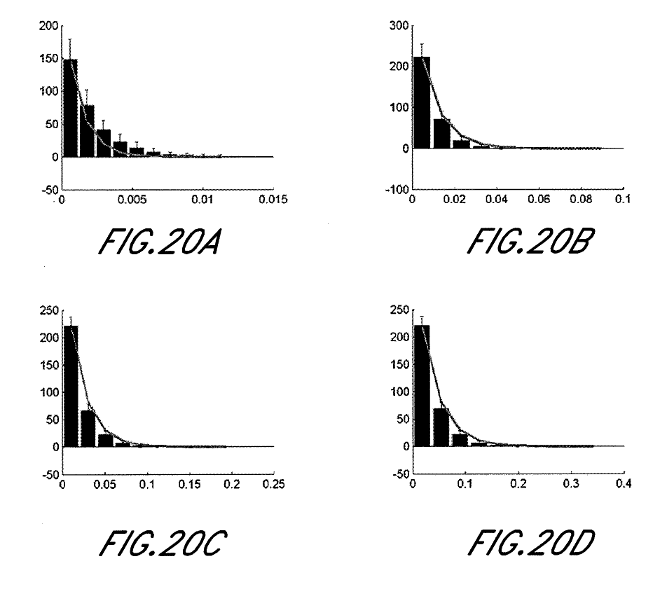

We now consider invariance with ocular aberrations: The statistical properties of laser speckle patterns do not change with the introduction of aberrations into the imaging system. If the intensity patterns predicted by the model are caused by coherent noise then the graphs shown above should be the same with the introduction of aberrations in the pupil plane. Aberrations of varying powers were shown not to affect the statistical properties of the intensity patterns formed in the image plane. Sample statistics taken from these aberrations are shown in FIG. 20.

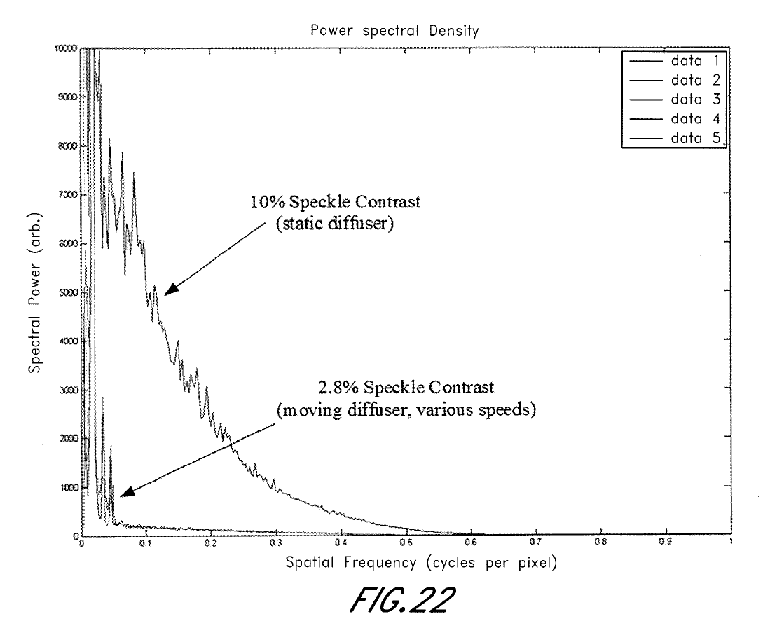

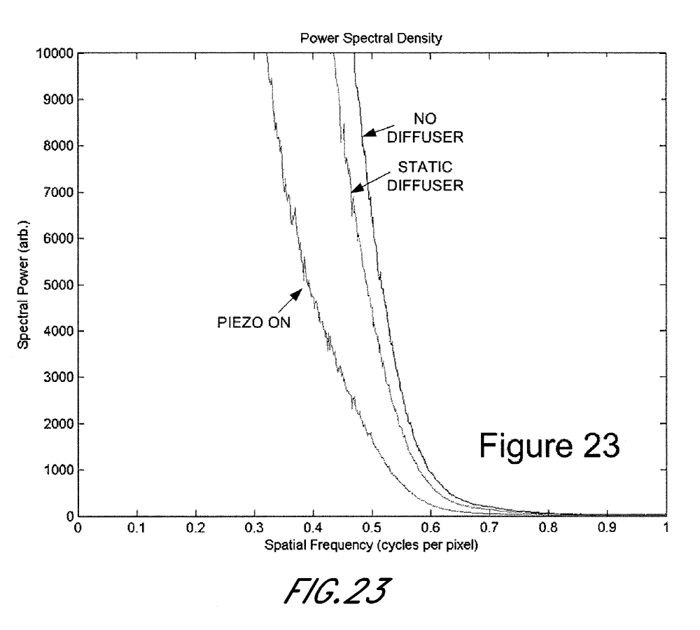

We now describe some experimental results: FIG. 22 shows that compared to a static diffuser, a (holographic) diffuser rotating on a motor is very effective at decreasing the spectral power of the speckle pattern at the lower spatial frequencies. However, the brightness penalty to achieve this level of speckle reduction is undesirably high. A similar effect can be achieved without such a high reduction in brightness using a piezo-electric actuator and a binary phase diffuser, as shown in FIG. 23.

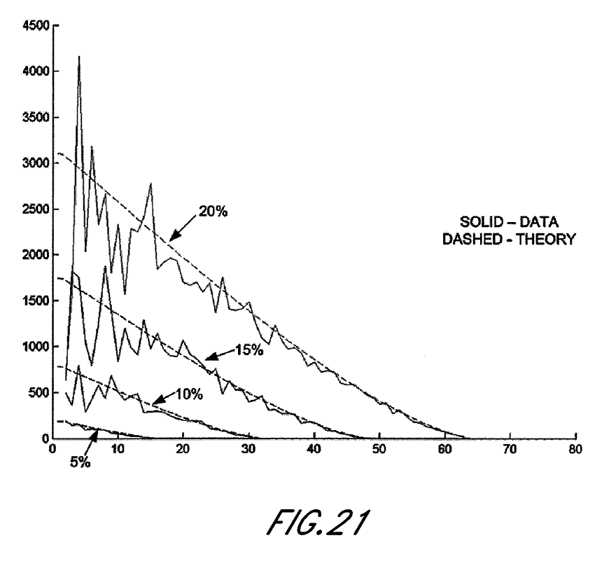

In summary, speckle can be accurately simulated when multiple points in the object contribute to each point in the image plane (i.e. the PSF of the imaging system is sufficiently large). The number of points passing through the aperture of the imaging system must also be sufficiently large (≧256 points) to produce an intensity pattern which follows speckle statistics. From the range of aperture sizes modelled it can be seen from FIG. 21 that as the size of the aperture of the imaging system increases, the distribution of speckle structure sizes increases, producing a more uniform field.

Furthermore, the moving diffuser can be seen to significantly reduce the spectral power spectrum of a speckle field measured experimentally at lower spatial frequencies. However, using too coarse a diffuser scatters light outside the collection angle of the final lens, significantly decreasing the brightness.

Using a pixellated binary phase diffuser scatters light inside the collection cone of the final projection lens. The pixel size of the diffuser is sufficiently small to generate ˜10 speckle patterns within a 10 μm distance. This range is then a sufficiently small to allow piezo actuation. The appearance of speckle in the final image is then decreased to a level which is tolerable to the viewer.

### Speckle Reduction—Implementation

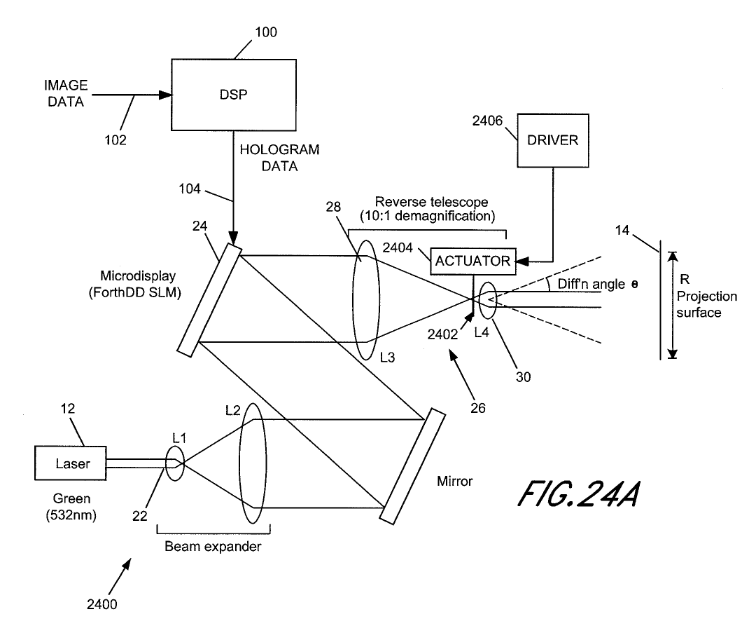

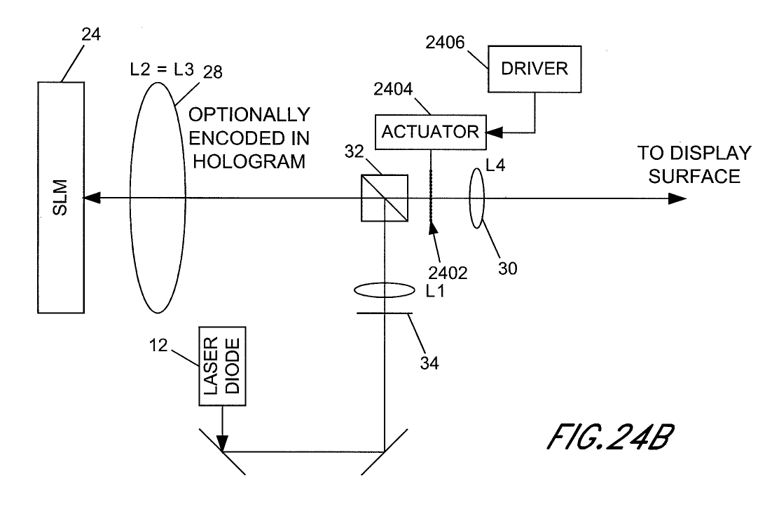

Referring now to FIG. 24a, this shows an embodiment of a holographic optical image display system 1600 for projecting an image onto a display surface 14; like elements to those of FIG. 2 are indicated by like reference numerals. A holographically generated intermediate image is formed at a Fourier transform plane, at which a piezo-electrically driven pixellated diffuser 2402 is located. The diffuser 2402 is linked by an arm (shown schematically) to a piezo-electric actuator 2404, coupled to a driver 2406.

FIG. 24b shows an alternative optical configuration using a reflective SLM in which the functions of lenses L2 and L3 are shared in a single lens 28 which may, in embodiments, be encoded in the hologram displayed on the SLM 24, as previously described. In this example system a waveplate 34 is employed to rotate the polarisation of the incident beam for the beamsplitter.

A holographically generated intermediate image is formed at the Fourier transform plane of the demagnifying optics, at which a piezoelectrically driven pixellated diffuser 2402 is located. Again the diffuser 2402 is linked by an arm (shown schematically) to a piezo-electric actuator 2404, coupled to a driver 2406. Optionally in this and the previously described arrangement an aperture may also be included in this plane to block off one or more of zero order (undiffracted light), the conjugate image, and higher diffraction orders.

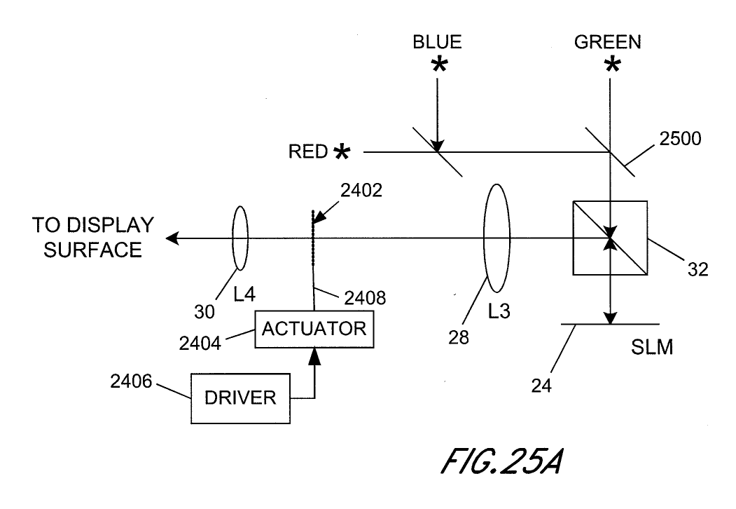

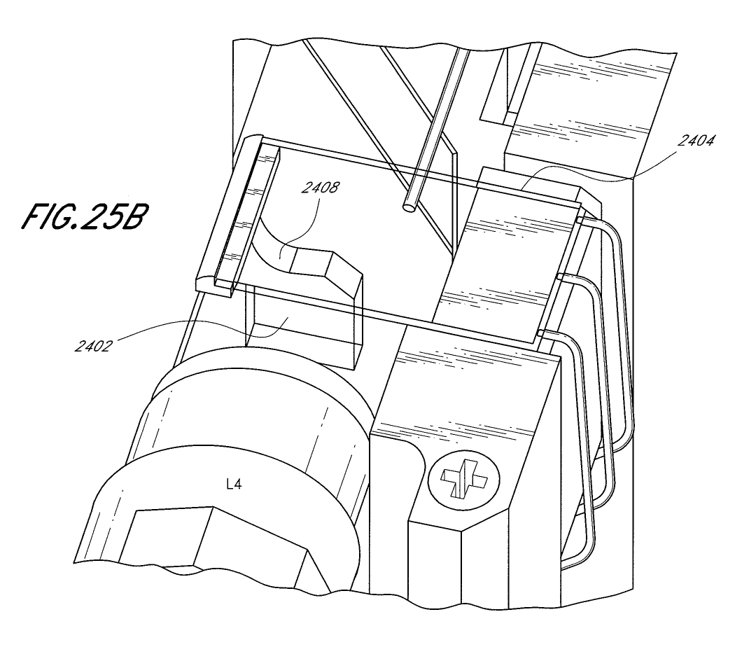

Referring now to FIG. 25a, this shows a schematic diagram of a colour holographic image display system embodying the invention in which like elements to those previously described are indicated by like reference numerals. The reflector 2500 is implemented using dichroic filters for the blue and red wavelengths. The diffuser 2402 is linked to piezo-electric actuator 2404 by an arm 2408. FIG. 25b shows details of a mechanical configuration for the system of FIG. 25a illustrating details of the diffuser and actuator; again like elements to those previously described are indicated by like reference numerals.

Embodiments of the system enable:

1. Temporal Reduction of Speckle, reducing the power of the speckle spectrum within a finite spatial frequency bandwidth.

As previously mentioned, OSPR reduces the appearance of speckle by randomising the phase of each pixel in the projected subframe image. The higher the rate at which the subframes are projected, the lower the power of the speckle spectrum (within a spatial frequency bandwidth determined by the pixel pitch of the holographic image). Put another way, the speckle contrast is reduced by a factor of 1/sqrt(N), where N is the number of subframes within the integration time of the eye. Using a diffuser in the intermediate image plane allows the rate at which the phase changes over the scale of a diffuser pixel to be increased beyond that achievable by the microdisplay alone. This effect could be achieved by increasing the subframe rate of the microdisplay, but this would use additional processing power.

2. Spatial reduction of speckle, increasing the bandwidth over which power in the speckle spectrum can be reduced.

When the diffuser is placed in the plane of the holographic image (i.e. the intermediate image plane), the image of the diffuser is projected onto the wall. Preferably the diffuser is substantially transparent, so that substantially only the phase of the projected image is affected by the diffuser. Without a diffuser, the phase within a pixel of the projected image (generated using OPSR) is uniform at a given instant in time (but varies randomly over time). Reducing the pixel pitch of the diffuser below that of the holographic image acts to reduce the area in the projected image over which the phase is uniform at a given instant in time. Over the integration time of the eye, regions in the projected image which have phases that vary randomly with respect to each other will produce multiple speckle patterns that will average out. To the eye it then appears as though these regions are incoherent with respect to each other.

Moving the diffuser rapidly generates random phases on a scale that is smaller than the projected image pixel. This effect could additionally or alternatively be achieved by increasing the number of pixels of the microdisplay (i.e. the spatial resolution of the projected image), but again this would use additional processing power.

Embodiments of the technique are implemented in a system which generates two-dimensional images holographically. This, inter alia, relaxes the time constraint on the diffuser. The diffuser can now complete the number of cycles used to reduce/remove speckle once every video frame rather than once every image row or once every image pixel. This substantially facilitates the use of a piezo-actuated diffuser.

In some preferred implementations a bending piezoelectric actuator is employed, in embodiments coupled to an arm holding the diffuser. In embodiments of the miniature holographic projector system, the stroke distance of the diffuser (˜10 μm) is sufficiently small to allow a bending piezo actuator to be used. Further, by attaching 2 piezo benders at right angles it is possible to achieve movement of the diffuser in two dimensions, preferably in two substantially orthogonal directions. This is helpful to avoid the appearance of “streaking” in the image. The frequency of the diffuser movement is preferably such that the period is less than 1/60 s. In embodiments the frequency of the diffuser movement may be such that the period is less than 1 sub-frame interval. However the effect appears to saturate at high speeds. Thus in embodiments an actuator frequency of 3-400 Hz was preferred over a higher frequency such as ˜2 KHz (which can cause audible noise).

We now describe a first example process for designing and constructing the diffuser. In this example a random binary ([0, π]) phase pattern described over a pixellated array with a 1.5 μm pitch is used. This was for a holographic image display system with a 3 μm intermediate image pixel pitch—one preferred ratio of the pixel pitch of the holographic image to the diffuser pixel pitch appears to be approximately 2:1. The diffuser was generated using a photo-lithography process (exposing, developing and etching a photoresist pattern on glass). This gives a flat diffuser surface profile that covers that phase range [0, π]. This helps to avoids light being scattered outside the final projections lens, increasing displayed image intensity, and reduces other artefacts caused by larger feature sizes. By contrast with a ground glass diffuser, a binary phase, pixellated diffuser has a predictable spatial frequency structure and hence a predictable cone of angles over which light is scattered. By adjusting the pixel pitch of the binary phase diffuser, the range of angles over which the light is scattered can be closely controlled. This is useful for finding a good balance between reduced speckle contrast and maximising both image brightness and projector throw angle.

In other arrangements, however, the optimal pixellated, quantised phase diffuser is a specially-computed pattern which may appear random to the eye but in fact offers improved performance in speckle reduction and throughput. Essentially a truly random phase diffuser will spread light into a “sinc”-type intensity distribution. However this distribution is not optimal for speckle reduction and one can generally do better than this to achieve improved speckle reduction. One preferred option is for the diffuser to be computed as a phase hologram which diffracts light into a uniform disc of a chosen angle, selected to fill (preferably substantially exactly) the clear aperture of the projection lens imaging the diffuser. This gives the optimal speckle reduction for a given clear aperture, but does not maximise depth of field.

Another alternative is for the diffuser to be a computed as a phase hologram which diffracts light into a disc whose intensity falls off with radius according to the equation 1−r². This gives optimal speckle reduction for a given depth of field, but diffracts light into a larger clear aperture than the uniform disc diffuser described above (hence potentially necessitating a larger/more complex projection lens).

For either of the above diffusers the spatial distribution of phases still looks random to the eye (these “computed” diffusers are not readily distinguishable by eye from truly “random” ones) but their effect on distributing incident light is quite different from a truly random phase diffuser. Background material on diffuser design can be found in “Binary optic diffuser design”, Fedor, Adam S. Proc. SPIE Vol. 4557, p. 378-385, Micromachining and Microfabrication Process Technology VII, Jean Michel Karam; John Yasaitis; Eds.

The skilled person will understand that applications for the techniques we have described are not limited to holographic image display systems displaying images on a planar or curved 2D screen but may also be employed when displaying or projecting an image or pattern on any surface using coherent light, in, particular holographically.

Applications for the described techniques we have described include in particular (but are not limited to) the following: mobile phone; PDA; laptop; digital camera; digital video camera; games console; in-car cinema; navigation systems (in-car or personal e.g. wristwatch GPS); head-up and helmet-mounted displays for automobiles and aviation; watch; personal media player (e.g. MP3 player, personal video player); dashboard mounted display; laser light show box; personal video projector (a “video iPod®” concept); advertising and signage systems; computer (including desktop); remote control unit; an architectural fixture incorporating a holographic image display system; more generally any device where it is desirable to share pictures and/or for more than one person at once to view an image.

No doubt many effective alternatives will occur to the skilled person and it will be understood that the invention is not limited to the described embodiments and encompasses modifications apparent to those skilled in the art lying within the spirit and scope of the claims appended hereto.

What is claimed is:

1. A holographic image display system for displaying an image holographically on a display surface, the system comprising:
a spatial light modulator (SLM) to display a hologram;
a light source to illuminate said displayed hologram;
projection optics to project light from said illuminated displayed hologram onto said display surface to form a holographically generated two-dimensional image, said projection optics being configured to form, at an intermediate image surface, an intermediate two-dimensional image corresponding to said holographically generated image;
a diffuser located at said intermediate image surface; and
an actuator mechanically coupled to said diffuser to, in operation, move said diffuser to randomise phases over pixels of said intermediate image to reduce speckle in an image displayed by the system.

2. A holographic image display system as claimed in claim 1 wherein said diffuser comprises a pixellated, quantised phase diffuser.

3. A holographic image display system as claimed in claim 2 wherein pixels of said diffuser have a pixel pitch of less than 5 μm.

4. A holographic image display system as claimed in claim 2 wherein a said pixel of said diffuser has one of a plurality of quantised phase levels, and wherein said quantised phase levels are computed to provide predetermined intensity distribution for light diffused by said diffuser.

5. A holographic image display system as claimed in claim 1 wherein said diffuser comprises a phase hologram.

6. A holographic image display system as claimed in claim 5 wherein said phase hologram is configured to diffuse light onto a disc.

7. A holographic image display system as claimed in claim 6 wherein said disc is substantially uniform.

8. A holographic image display system as claimed in claim 6 wherein said disc has an intensity which falls off with radius r as approximately (1−r²).

9. A holographic image display system as claimed in claim 1 wherein said diffuser configured to diffuse light onto a disc, wherein said projection optics comprises an imaging device to image said diffuser, and wherein said disc at least substantially fills a clear aperture of said imaging device imaging said diffuser.

10. A holographic image display system as claimed in claim 1 wherein said diffuser has a minimum feature size of a fraction of a pixel pitch of said intermediate two-dimensional image, wherein said fraction is at least 1/100, 1/50 or 1/10.

11. A holographic image display system as claimed in claim 2 wherein said activator comprises a piezoelectric activator, and further comprising a driver for said piezoelectric activator, and wherein, in operation, said driver is configured to move said diffuser a distance of at least twice said diffuser pixel pitch, preferably at least five times said diffuser pixel pitch.

12. A holographic image display system as claimed in claim 1 wherein said system is configured to move said diffuser sufficiently quickly for a changing speckle pattern in an image displayed by the system, resulting from a changing random phase pattern imposed by said moving diffuser on said pixels of said intermediate image, to be integrated in the eye of a human observer to reduce a perceived level of speckle in an image displayed by the system.

13. A holographic image display system as claimed in claim 1 further comprising a processor having an input to receive image data for display and having an output for driving said SLM, wherein said processor is configured to process said image data to generate hologram data for said hologram displayed on said SLM, wherein said pixels of said intermediate image formed by said displayed hologram have an intermediate image pixel pitch, and wherein said diffuser has pixels with a diffuser pixel pitch smaller than said intermediate image pixel pitch.

14. A holographic image display system as claimed in claim 13 wherein said processor is configured to generate a plurality of temporal holographic subframes for display in rapid succession on said SLM such that corresponding temporal subframe images on said display surface average in an observer's eye to give the impression of said displayed image.

15. A holographic image display system as claimed in claim 1 wherein said actuator is configured to move said diffuser in two dimensions.

16. A method of reducing speckle in a holographic image display system for holographically displaying an image comprising a plurality of pixels on a display surface, the system comprising: a spatial light modulator (SLM) to display a hologram; a light source to illuminate said displayed hologram; projection optics to project light from said illuminated displayed hologram onto said display surface to form a holographically generated two-dimensional image, said projection optics being configured to form, at an intermediate image surface, an intermediate two-dimensional image corresponding to said holographically generated image; and a diffuser located at said intermediate image surface, the system being configured to generate a plurality of temporal holographic subframes for display in rapid succession on said SLM such that corresponding temporal subframe images on said display surface average in an observer's eye to give the impression of said displayed image; the method comprising moving said diffuser to provide within the area of each said pixel a plurality of different phases sufficiently quickly for a resulting changing speckle pattern to be integrated in the eye of a human observer to reduce a perceived level of speckle.

17. A method as claimed in claim 16 wherein said diffuser comprises a pixellated, quantised phase diffuser with pixels having a pitch less than a pitch of pixels of said displayed image at said intermediate image surface, such that said speckle is reduced at a spatial frequency higher that a maximum spatial frequency of said displayed image.

18. A method as claimed in claim 16 wherein said diffuser has a pattern computed to substantially match an acceptance angle of an imaging device imaging said intermediate imaging surface of said projection optics.

19. A method as claimed in claim 16 wherein said diffuser has a pattern computed to substantially maximise speckle reduction for a determined depth of field of said holographic image display system.

20. A method as claimed in claim 16 wherein said moving comprises moving said diffuser in two dimensions.

21. An image display system to project an image onto a display surface using at least partially coherent light, the system comprising:
a spatial light modulator (SLM) to display a two-dimensional image;
an at least partially coherent light source to illuminate said displayed image on said SLM;
projection optics to project light from said illuminated display image onto said display surface to form a two-dimensional image, said projection optics being configured to form an intermediate two-dimensional image corresponding to said displayed image;
a pixellated, quantised phase diffuser located at a position of said intermediate two-dimensional image; and
a piezoelectric actuator mechanically coupled to said diffuser to, in operation, move said diffuser to change a speckle pattern of said projected two-dimensional image, whereby, in operation, said changing speckle pattern of said projected two-dimensional image resulting from movement of said diffuser averages in a human observer's eye to reduce a perceived level of speckle.

22. An image display system as claimed in claim 21 wherein said intermediate image has an intermediate image pixel pitch, and wherein said diffuser has a pixel pitch less than said intermediate image pixel pitch.

23. An image display system as claimed in claim 21 wherein said actuator is configured to move said diffuser in two dimensions.

24. An image display system as claimed in claim 21 wherein a said pixel of said diffuser has one of a plurality of quantised phase levels and wherein said quantised phase levels are computed to provide predetermined intensity distribution for light diffused by said diffuser.

25. An image display system as claimed in claim 21 wherein said diffuser comprises a phase hologram.

26. An image display system as claimed in claim 25 wherein said phase hologram is configured to diffuse light onto a disc, wherein said disc is substantially uniform, wherein said projection optics comprises an imaging device to image said diffuser, and wherein said disc at least substantially fills a clear aperture of said imaging device imaging said diffuser.

27. An image display system as claimed in claim 25 wherein said phase hologram is configured to diffuse light onto a disc and wherein said disc has an intensity which falls off with radius r as approximately (1−r²).
